(19) United States
(12) Patent Application Publication
(10) Pub. No.: US 2026/0038204 A1
(43) Pub. Date: Feb. 5, 2026

(54) THREE-DIMENSIONAL MODELING USING DETACHED FEATURE MESHES

(71) Applicant: Pixar, Emeryville, CA (US)

(72) Inventors: Ana G. LACAZE JORDAN, San Rafael, CA (US); Anna-Christine LYKKEGAARD, Oakland, CA (US); David B. MUNIER, Lafayette, CA (US); Jonathan W. PAGE, Martinez, CA (US)

(21) Appl. No.: 18/788,722

(22) Filed: Jul. 30, 2024

(51) Int. Cl. G06T 17/20

(52) U.S. Cl. CPC G06T 17/20

(57) ABSTRACT

Embodiments provide for improved computer modeling are provided. A three-dimensional (3D) base mesh corresponding to at least a portion of a character and a 3D feature mesh corresponding to a feature of the character is accessed. One or more portions of the 3D feature mesh are deformed using surface projection based on an overlapping region for the 3D base mesh and the 3D feature mesh to generate a first modified 3D feature mesh. At least one of a texture or normals of the first modified 3D feature mesh is modified based on at least one of a texture or normals of the 3D base mesh to generate a textured 3D feature mesh. An image is rendered based on the 3D base mesh and the textured 3D feature mesh.

### BACKGROUND

Artists can use a wide variety of animation techniques and styles to create visually appealing characters and designs. For example, three-dimensional (3D) computer modeling is often used to create character designs and generate 3D animations and images. While such computer generated animations can be highly engaging, they are also quite limited in their flexibility. For example, the faces of 3D character models, where substantial expressivity is often preferred, are generally designed as monolithic units. That is, the features of the characters are often defined as a single topology (e.g., a set of vertices connected by edges and/or faces), such that animating the features (e.g., opening the character's mouth) necessarily modifies the topology of other features (e.g., pulling or pushing the various vertices, edges, and/or faces in different directions). These efforts can therefore create substantial visual artifacts that can detract from the imagery, requiring significant manual effort to identify and correct.

### SUMMARY

In some embodiments of the present disclosure, a method is provided. The method includes accessing a three-dimensional (3D) base mesh corresponding to at least a portion of a character; accessing a 3D feature mesh corresponding to a feature of the character; deforming one or more portions of the 3D feature mesh using surface projection based on an overlapping region for the 3D base mesh and the 3D feature mesh to generate a first modified 3D feature mesh; modifying at least one of a texture or normals of the first modified 3D feature mesh based on at least one of a texture or normals of the 3D base mesh to generate a textured 3D feature mesh; and rendering a first image based on the 3D base mesh and the textured 3D feature mesh.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; and a computer program product embodied on a computer-readable storage medium comprising code for performing the aforementioned methods as well as those further described herein.

The following description and the related drawings set forth in detail certain illustrative features of one or more embodiments.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts an example workflow for improved modeling using detached features, according to some embodiments of the present disclosure.

FIGS. 2A, 2B, 2C, 2D, and 2E depict an example workflow for incorporating detached feature meshes, according to some embodiments of the present disclosure.

FIG. 3 depicts an example technique for subsurface scattering with detached features, according to some embodiments of the present disclosure.

FIG. 4 is a flow diagram depicting an example method for modeling meshes using detached features, according to some embodiments of the present disclosure.

FIG. 5 is a flow diagram depicting an example method for computer modeling, according to some embodiments of the present disclosure.

FIG. 6 depicts an example computing device configured to perform various aspects of the present disclosure.

### DETAILED DESCRIPTION

In some aspects of the present disclosure, techniques and systems are described to utilize detached feature meshes generate more engaging and diverse 3D models (e.g., character models) with reduced or eliminated visual artifacts and significantly improved mesh flexibility.

In some aspects, detached feature meshes can enable character design that far surpasses the modeling that is possible using conventional mesh topologies. For example, in some aspects, detached feature modeling can enable character designs that include dynamic facial features moving independently of one another (e.g., reminiscent of conventional two-dimensional drawn animations). In some aspects, as an example, detached mesh modeling can enable features such as the mouth of the character to easily occupy the entire face, to shrink down to very small sizes, and/or to move from ear to ear without negatively affecting the topology or other features on the face. As another example, the character's nose may disappear completely off the face for visual impact.

Achieving these extreme movement ranges is not feasible with conventional facial or character rigging approaches. For example, as discussed above, the stretching and/or compression that the mesh geometry and/or textures undergo with such animation is very difficult, and sometimes impossible, to reconcile. This requires costly shot clean-up for conventional modeling methods. As a result of the relatively limited conventional topologies, some conventional approaches have relied on building multiple pose-specific variants for each character (e.g., where each variant has a manually designed topology based on the corresponding pose), but this model duplication not only incurs substantial manual effort and time, but also significantly increases computational expense (e.g., to store and maintain multiple variants for each character).

In some aspects of the present disclosure, detached facial features (DFF) are used. Although facial features are used as example detached meshes in some aspects of the present disclosure, the techniques described herein can be readily applied to any computer modeling where multiple features can be modeled and animated separately and incorporated or aggregated into a single visual model. For example, a base mesh corresponding to the head of a character may be augmented using detached feature meshes corresponding to the character's nose, mouth, ears, eyes, and the like. As used herein, a feature mesh corresponds to any visual feature of a model, such as facial features, fingers or other appendages, and the like. In some aspects, a base mesh corresponds to the model onto which the feature meshes can be integrated to generate visual output.

In some aspects, one or more features or parts of the character (e.g., the head) can be modeled independently. For example, in some aspects, a blank head mesh with eyes can be modeled, as well as a standalone mouth mesh, a nose mesh, and two independent ear meshes. In some aspects, some features (such as eyes) may be incorporated into the base mesh topology. For example, inclusion of the eyes in the base mesh can help preserve visual character recognition (e.g., allowing viewers to readily recognize the character's identity) while use of separate meshes for other features (such as the mouth of the character) can improve the character's expressivity.

In some aspects, even though the character is built and controlled using independent meshes, various techniques are provided to blend the meshes and allow the resulting aggregate model to be perceived or visualized as a conventional 3D character with a continuous surface topology. In some aspects, coordinating the movements of separately modeled feature meshes (e.g., the nose and mouth) across an otherwise featureless face can create a multitude of rigging and shading concerns. For example, the edges of the feature meshes may be blended into the base mesh both geometrically and texturally to hide the seams between these discrete meshes. In some aspects of the present disclosure, a standardized approach is provided to perform this dynamic blending to give animators a consistent rig that works in multiple separate contexts. For example, in some aspects, the DFF modeling can be implemented sufficiently fast enough in a display for camera and animation users to pose characters and view the resulting combinations without significant delays or visual separation between the meshes. This can enable significantly improved modeling. Further, in some aspects, the DFF Modeling techniques described herein can enable offline rendering quickly and seamlessly, resulting in visually appealing imagery without significant artifacts or errors.

### Example Workflow for Improved Modeling Using Detached Features

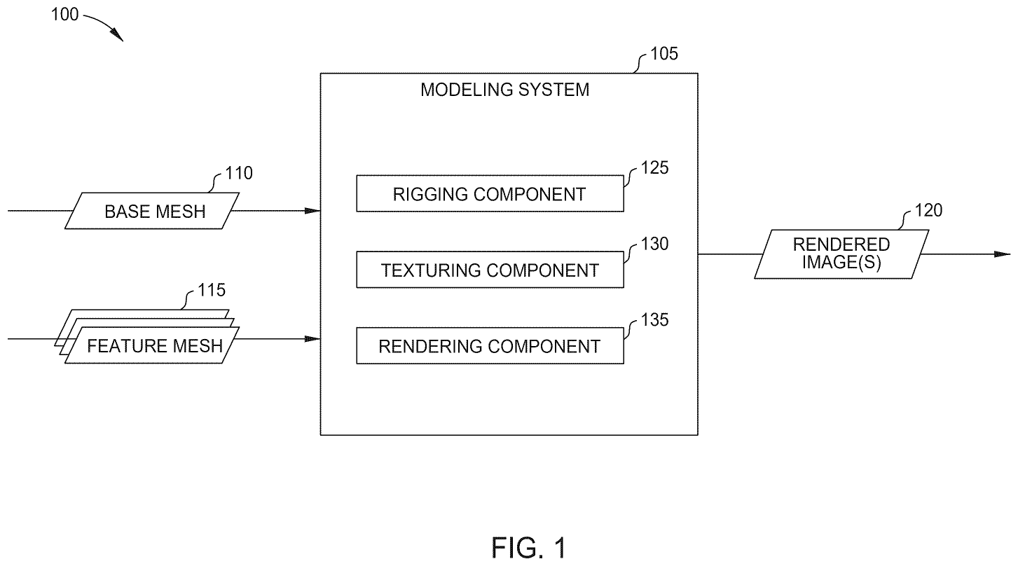

FIG. 1 depicts an example workflow 100 for improved modeling using detached features, according to some embodiments of the present disclosure.

In the illustrated example, a modeling system 105 accesses a base mesh (e.g., the base mesh 110) and a set of one or more feature meshes 115 and aggregates them (e.g., based on user-guided animation) to generate rendered image(s) 120. As used herein, accessing data may generally include receiving, retrieving, requesting, obtaining, generating, collecting, or otherwise gaining access to the data. For example, the modeling system 105 may retrieve the base mesh 110 and/or feature meshes 115 from a local repository, from a remote repository, from a user, and the like. The rendered image(s) 120 are generally representative of any computer generated imagery depicting the base mesh 110 and/or feature mesh(es) 115, such as imagery rendered as part of the modeling process (e.g., output on a display to the animator), imagery rendered as part of the final animation (e.g., a sequence of images forming a video animation), and the like.

Although depicted as a discrete computing system for conceptual clarity, the modeling system 105 is generally representative of any computing system (or combination of systems), and may be implemented using hardware, software, or a combination of hardware and software distributed across any number and variety of computing systems. The modeling system 105 is generally representative of any combination of systems or components used to generate, modify, texture, shade, render, and/or perform any other actions to perform the operations described herein. For example, the modeling system 105 may include texturing systems, rendering systems, and the like. Although the illustrated workflow 100 depicts a head-shaped base mesh 110, as discussed above, a variety of base meshes may be used to integrate the feature meshes 115. In some aspects, as discussed above, the base mesh 110 may be a 3D mesh (e.g., a set of vertices with corresponding edges and/or faces connecting the vertices) corresponding to the head of a character (which may include the neck of the character and/or a portion or the entirety of the character's body). In some aspects, the base mesh 110 may include one or more features that are intended to be animated as an integral part of the head (rather than as separate features), such as eyes, hair, ears, and the like. Generally, the integrated features may vary depending on the particular implementation.

The feature meshes 115 are generally representative of any 3D feature that can be used to augment the base mesh 110 for visual appeal while retaining independent animation abilities, such as the mouth of the character, the nose of the character, the ears of the character, the eyes of the character, and the like. Generally, the discrete features may vary depending on the particular implementation.

In some embodiments, as users position the individual feature meshes 115, the overlapping edges can be projected onto the geometry of the base mesh 110 in order to blend with the main base shape. In some embodiments, to allow the mouth (or other opening) of the character to be opened, the modeling system 105 can dynamically calculate a signed distance field to weigh rig influences on the blended meshes. This reveals the mouth cavity inside in real-time in the animation software. In some aspects, a similar approach using signed distance field can be used in the render operations to calculate the correct way to adjust the render to reveal the inside of the mouth. As discussed above, users (e.g., animators) can then shape and move the face and the face features independently or in concert as desired.

Traditional face shading techniques generally assume that the shaded topology is static, as well as that the location of the features (e.g., the nose and mouth) do not change. In some embodiments of the present disclosure, improved shading and rigging can be used to calculate blend areas on parts of the face so that the surfaces may be merged (visually) seamlessly. These transition areas between the feature meshes 115 and the base mesh 110 may be automatically and dynamically maintained without manual adjustment in some embodiments.

In some embodiments, when the modeling system 105 shades each detached facial feature mesh 115, the modeling system 105 can trace the UV manifold from the underlying head mesh and, where the meshes overlap, the modeling system 105 can blend the two textures into the visible surface(s). As a result, the modeling system 105 is not constrained by the stretching and compression of textures as the features move, grow, and/or shrink on the face of the character. In some embodiments, self-intersections of the discrete facial features can be resolved to effectively treat the group of meshes as a constructive solid geometry union, (e.g., treating the meshes as one topology, in effect), enabling correct raytracing for subsurface scattering, as discussed in more detail below.

In some aspects, in addition to providing greater freedom and enabling literal translation of varied expressions from storyboards into 3D models, the techniques described herein can also allow a wide variety of character designs to be created effortlessly. For example, users may mix and match various base meshes 110 with various feature meshes 115 (e.g., different nose, mouth, and ear shapes may be added to different head shapes) to quickly create new characters. This can allow a wide variety of 3D character designs to be implemented using minor polish adjustments without a large time investment for re-sculpting or re-rigging.

In the illustrated example, the modeling system 105 includes a rigging component 125, a texturing component 130, and a rendering component 135. Although depicted as discrete components for conceptual clarity, the operations of the depicted components (and others not illustrated) may be combined or distributed across any number of components.

In the illustrated example, the rigging component 125 may be used to blend the topologies of the feature meshes 115 with the base mesh 110, as discussed in more detail below. For example, once a given feature mesh 115 has been positioned (e.g., after a user has defined the shape, orientation, and/or position of the feature mesh 115 relative to the base mesh 110), the rigging component 125 may dynamically modify the feature mesh 115, base mesh 110, or both to blend the topologies to present a visually seamless model. In some embodiments, the rigging component 125 may identify overlapping region(s) of the meshes (e.g., regions where the edges of the feature mesh 115 intersect or overlap with the base mesh 110, and vice versa) and use surface projection to move or deform one or more portions of either (or both) meshes to align the portions in 3D space. In some aspects, these regions may be referred to as overlapping and/or intersecting portions of the mesh(es). For example, as discussed in more detail below, the rigging component 125 may move one or more vertices, edges, and/or faces of the feature mesh 115 and/or base mesh 110 to align the components. In some embodiments, the rigging component 125 may use a weighted projection to align the meshes, such as where the amount that each portion of each mesh is deformed is defined based at least in part on the distance between that portion and the overlap or intersection of the meshes (e.g., where portions nearer to the intersection may be moved more to smooth the transition, as compared to portions further from the intersection). In some embodiments, a falloff distance may be used to define the maximum distance from the intersection at which components of the mesh(es) may be moved by the rigging component 125, as discussed in more detail below.

In some embodiments, in addition to modifying the position(s) of one or more components of the feature mesh 115 and/or base mesh 110, the rigging component 125 may further perform operations such as removing portion(s) of the base mesh 110 to create holes or gaps, such as for the mouth. For example, in some embodiments, the rigging component 125 may use a dummy or rig geometry corresponding to the feature mesh 115 (e.g., a mesh that follows the articulation of the mouth or lips, such as outlining the current edges of the lips and aligned with the lips). The rigging component 125 may then extrude this rig geometry such that it intersects with base mesh 110 (and is aligned along the orientation of the feature mesh 115), and may then remove the portion(s) of the base mesh 110 that are contained within the extruded rig mesh. In some aspects, these portions may be referred to as overlapping and/or intersecting portions of the mesh(es). For example, the rigging component 125 may compute a signed distance field (SDF) for the base mesh 110 with respect to the feature mesh 115 to identify components of the base mesh 110 that are within the extruded rig. These components may be removed (and the rig mesh may similarly be deleted or hidden), creating a hole in the base mesh 110 that is aligned with the outline of the mouth (or other opening).

In the illustrated workflow 100, the texturing component 130 may be used to modify or adjust the texturing of the feature mesh 115 and/or the base mesh 110 based on the overlapping portion(s) or region(s). For example, in some embodiments, the texturing component 130 may identify the intersection between the meshes, and identify or define the overlapping region as the portion(s) of the feature mesh 115 beginning at the intersection point and including components within a defined distance from the intersection. In some aspects, these regions may be referred to as overlapping and/or intersecting portions of the mesh(es). In some embodiments, the texturing component 130 may trace or project the UV mapping of the base mesh 110 to the feature mesh 115 in the overlapping region, allowing the texture of the base mesh 110 to be transferred (at least partially) to the feature mesh 115. For example, the texturing component 130 may use a weighted blending (including a falloff value) where the texturing component 130 blends the textures of the base mesh 110 and feature mesh 115 (using corresponding UV mappings). In some embodiments, the texturing component 130 may set the texture of the feature mesh 115 to be the same as the texture of the base mesh 110 at the intersection point, and progressively blend the textures of each mesh together across the defined overlapping region. At the other end of the overlapping region, the texture of the feature mesh 115 may be the original texture of the feature. In this way, the texturing component 130 can dynamically blend the textures appropriately to hide the seam between the meshes.

In some aspects, the texturing component 130 can generally perform shading operations to blend the meshes. For example, in addition to or instead of performing texture blending, the texturing component 130 may perform or facilitate shading modulation (e.g., procedurally at render time) based on the overlap, and/or blending of surface normals within the overlapping area of the meshes. That is, the texturing component 130 may blend other shading or texturing components, such as surface normals and/or procedural shading signals for the overlapping regions.

In some embodiments, the rendering component 135 may be used to render image(s) of the combined meshes in order to generate rendered images 120. In some embodiments, the rendering component 135 may use a modified subsurface scattering (SSS) approach to generate improved depictions of the combined mesh. For example, as discussed below in more detail, conventional subsurface scattering computation may result in inaccurate results for the aggregated model, as the meshes may remain distinct elements in the 3D space. By using a modified algorithm, the rendering component 135 may enable more accurate subsurface scattering to be computed, resulting in seamless and effective visual combination of the discrete meshes.

In the illustrated workflow 100, the rendered images 120 may be used for any purpose. For example, the rendered images 120 may be output via a display (e.g., for the user performing the animation process), allowing users to view and modify the positioning, size, and/or orientation of the feature mesh(es) 115 relative to the base mesh 110 to generate the desired animations. Further, once the users are satisfied with the animation, the rendered images 120 may be generated and stored for future viewing (e.g., as part of a movie, episode, short, or other animation content).

### Example Workflow for Incorporating Detached Feature Meshes

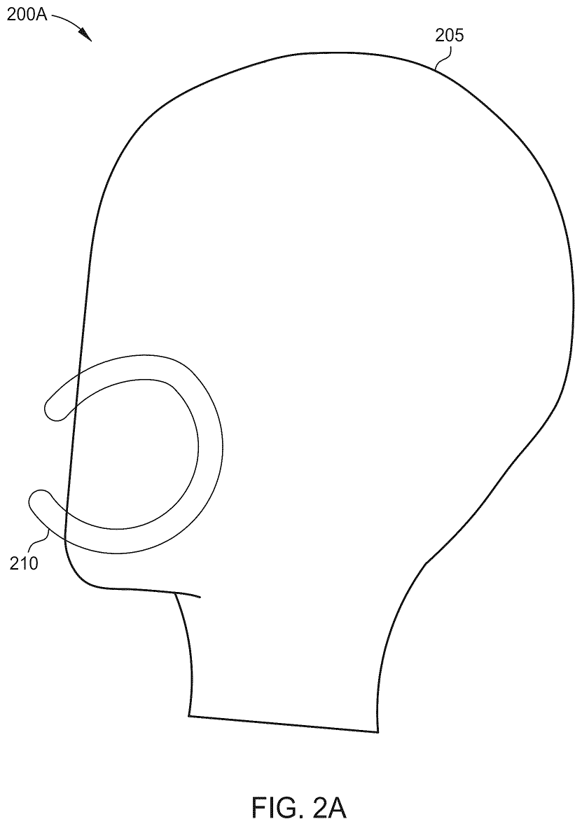

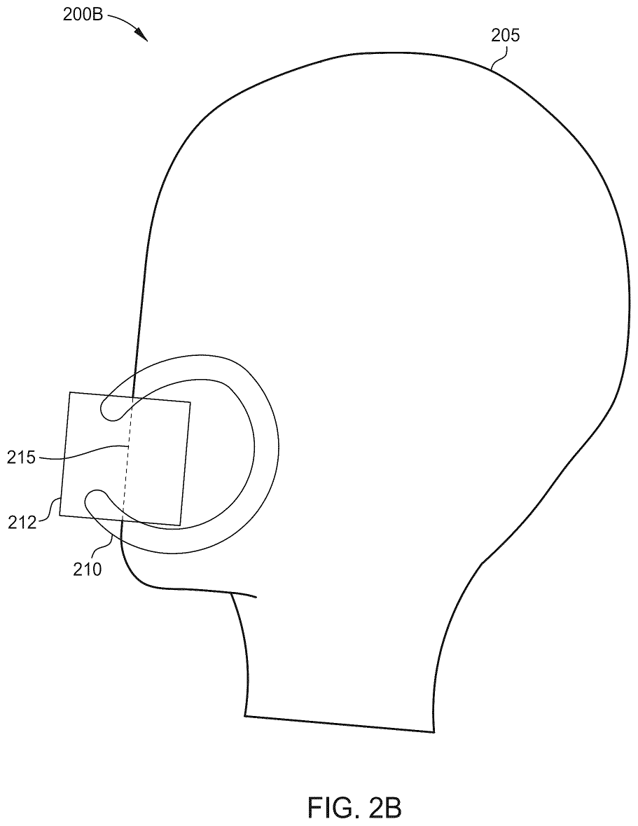

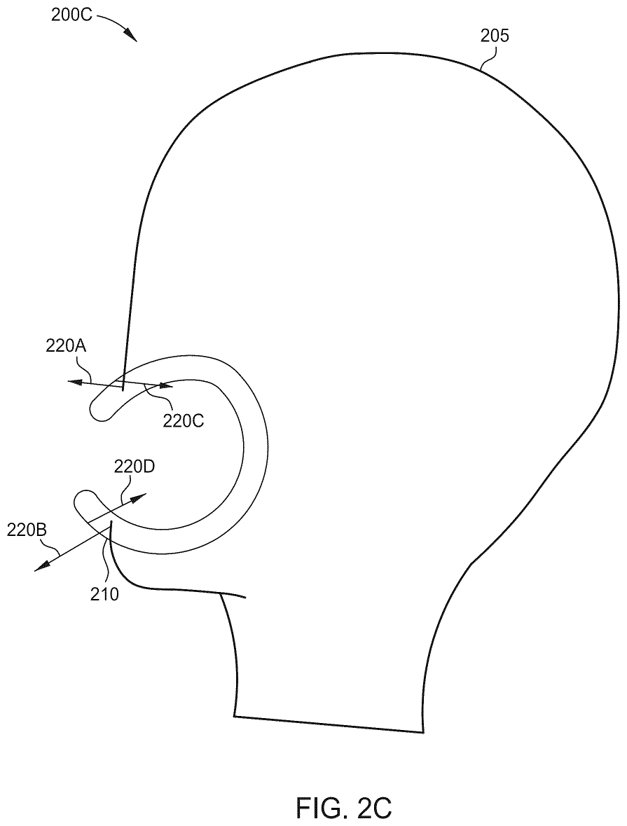

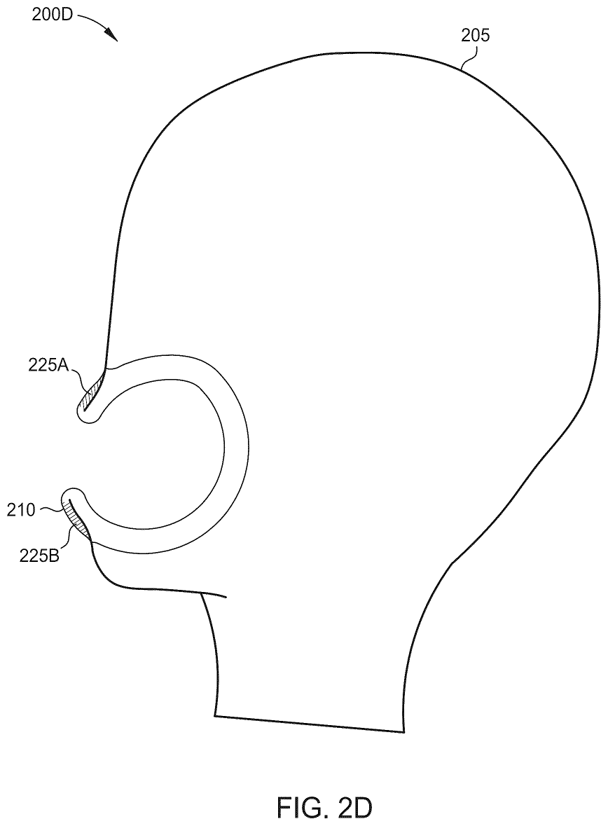

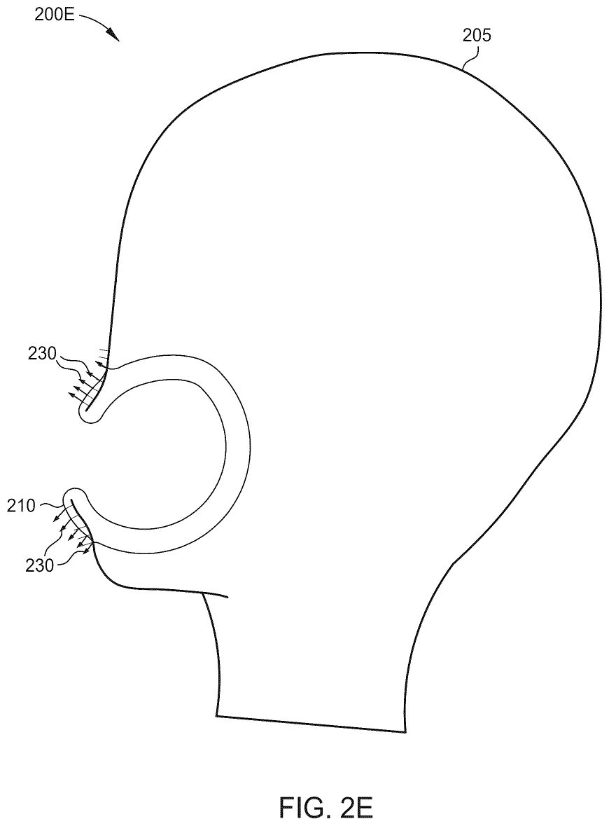

FIGS. 2A, 2B, 2C, 2D, and 2E depict an example workflow for incorporating detached feature meshes, according to some embodiments of the present disclosure. In some embodiments, the illustrated workflow is performed by a modeling system, such as the modeling system 105 of FIG. 1, to aggregate feature meshes and base meshes.

As illustrated in FIG. 2A, at 200A, a base mesh 205 (e.g., a 3D model of at least the head of a character, such as the base mesh 110 of FIG. 1) and a feature mesh 210 (e.g., a 3D model of the mouth and/or lips of the character, such as the feature mesh 115 of FIG. 1) are being aggregated to form a character. Specifically, in the illustrated example, the base mesh 205 generally depicts the shape of the character's head, but lacks one or more facial features (e.g., eyes, a nose, ears, a mouth, and the like). Although the illustrated base mesh 205 is featureless, in some aspects, the base mesh 205 may include one or more features (such as eyes). For example, the base mesh 205 may include any features (as part of the base mesh topology) that are not intended or desired to move independently from the base mesh 205 (e.g., if the eyes are intended to remain fixed on the character's head, but other features are intended to move relative to the head). Further, although the illustrated example depicts a head for conceptual clarity, in some embodiments, the base mesh 205 may include further portions of the character. For example, the base mesh 205 may correspond to the entire body of the character (including the head) but lacking one or more facial features.

In the illustrated example, the feature mesh 210 corresponds to the mouth of the character and includes lips (e.g., the portion of the feature mesh 210 that extends to the outside of the base mesh 205) as well as the inside of the character's mouth (e.g., the portion of the feature mesh 210 that is within the base mesh 205). Although not illustrated for conceptual clarity, in some aspects, the feature mesh 210 may include other details such as teeth, a tongue, and the like. Although the illustrated example includes a single feature mesh 210, in some embodiments, any number of feature meshes 210 may be used. For example, the workflow may further include use of a nose mesh, ear meshes, and the like.

As illustrated, the base mesh 205 and the feature mesh 210 are discrete meshes. That is, each has its own topology (e.g., set of vertices connected by edges and/or faces) and the two meshes do not share any components or portions of their topologies. As discussed above, this can allow users (e.g., animators) to readily move the feature mesh 210 to any position on or around the base mesh 205 (potentially subject to rigging constraints), as well as to freely change the orientation, size, and/or shape of the feature mesh 210 (again, potentially subject to rigging constraints) without affecting the topology of the base mesh 205.

As depicted in FIG. 2B, at 200B, a rig geometry 212 corresponding to the feature mesh 210 is used to create a hole in the base mesh 205. Specifically, as discussed above, the rig geometry 212 may correspond to or align with the outline or edges of the feature mesh 210 (or otherwise indicate where the hole should be placed). For example, in the illustrated workflow, the rig geometry 212 is automatically aligned to follow the intersection between the feature mesh 210 and the base mesh 205 at the mid or center point of the feature mesh 210 (e.g., such that the edge of the resulting hole is within the feature mesh 210 and is not visible).

The rig geometry 212 is then extruded, as illustrated, to extend through the base mesh 205. Various techniques, such as a SDF, can then be used to identify portions of the base mesh 205 (e.g., the portion 215) that are within the extruded rig geometry 212, as compared to portions that are external to the rig geometry 212. In the illustrated example, the identified portion 215 of the base mesh 205 can then be removed to create the mouth hole in the character's face (allowing visibility into the mouth). Generally, “removing” the portion may correspond to deleting the corresponding elements, hiding the corresponding elements, or otherwise causing the elements to be invisible or unseen. In some embodiments, this SDF approach can also be used during shading and/or rendering to create the mouth opening, as discussed above.

As illustrated in FIG. 2C, at 2000, the topologies of the feature mesh 210 and/or base mesh 205 may then be modified to blend the transition between the feature and the head. In some embodiments, the modeling system 105 can identify the overlapping region(s) or portion(s) of the meshes, and dynamically deform one or more elements of one or both meshes to align in space. Specifically, as illustrated by the arrows 202A and 220B, the modeling system 105 may shift or translate the edge of the base mesh 205 (e.g., the points at or near the intersection) outwards to bring these elements closer to the corresponding elements on the feature mesh 210. Further, as illustrated by the arrows 220C and 220D, the modeling system 105 may shift or translate the edge of the feature mesh 210 (e.g., the points at or near the intersection) towards the corresponding elements of the base mesh 205.

In some aspects, the modeling system 105 seeks to align the mesh topologies at the visible intersection point (e.g., where the external faces of the mouth and head meet). In some embodiments, as discussed above, a defined portion of one or both meshes may similarly be defined as the overlapping area, and the modeling system 105 may move the elements of the overlapping area towards each other based on a defined falloff weighting (e.g., where the elements at the intersection are moved the most, and elements further from the intersection are moved less until the falloff point is reached). This may enable the modeling system 105 to generate a smooth topology transition between the feature mesh 210 and the base mesh 205, hiding the seam and ensuring visual consistency.

As illustrated in FIG. 2D, at 200D, the modeling system 105 can then modify the texture of the feature mesh 210 based on the texture of the base mesh 205. Specifically, as illustrated by the regions 225A and 225B, the modeling system 105 may blend the textures such that, at the visible intersection point, the texture of the feature mesh 210 matches or is equal to the texture of the base mesh 205 at the corresponding position (determined based on the UV mappings) and, at the opposite end of the regions 225 (further from the base mesh 205), the texture of the feature mesh 210 is unmodified. Between these points, the modeling system 105 may scale or weight the textures to enable a smooth blend between the texture of the feature mesh 210 and the texture of the base mesh 205. As discussed above, this UV map tracing for distinct meshes allows the feature mesh 210 to be moved freely without affecting the texturing (e.g., UV mapping) of the underlying base mesh 205. Further, tracing the texture from the base mesh 205 to the feature mesh 210 allows the modeling system 105 to hide the seam between the meshes, such that they can visually appear as a single mesh.

As illustrated in FIG. 2E, at 200E, the modeling system 105 can further modify the shading and/or texturing of the feature mesh 210 based on the base mesh 205. Specifically, as illustrated by the arrows 230, the modeling system 105 may blend the surface normals of the base mesh 205 and/or the surface normals of the feature mesh 210 in the overlapping area. That is, the surface normals of the base mesh 205 may be blended with the surface normals of the feature mesh 210 (and vice versa) by modifying or updating the normals in order to blend the mesh normals together within the overlapping region. In some aspects, this surface normal blending can enable accurate illumination and visual consistency of the blended meshes.

### Example Technique for Subsurface Scattering with Detached Features

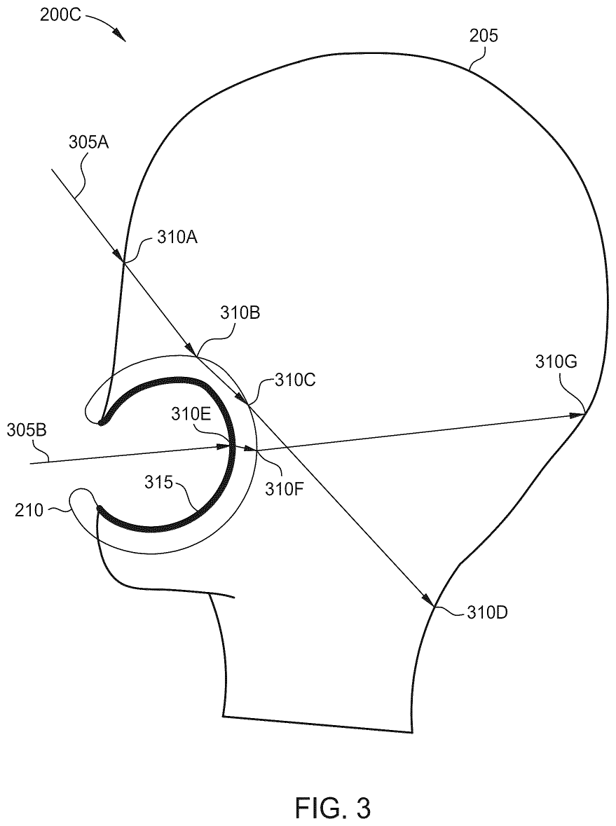

FIG. 3 depicts an example technique 300 for subsurface scattering with detached features, according to some embodiments of the present disclosure. In some embodiments, the illustrated technique 300 is performed by a modeling system, such as the modeling system 105 of FIG. 1 and/or the modeling system discussed above with reference to FIG. 2, to improve rendering of combined feature meshes and base meshes.

As depicted in the illustrated example, the presence of the mouth cutout and/or the overlapping geometry can create inconsistencies in subsurface scattering computations, which may result in visual artifacts or sub-optimal results if handled using conventional approaches. In some embodiments, subsurface scattering is used to determine or mimic how light scatters within objects, and can result in substantially improved visual imagery. In some embodiments, subsurface scattering is implemented using raytracing (e.g., tracing the paths of rays 305A, 305B, and the like to determine how to render the image). In some aspects, the rays 305 may generally be referred to as camera rays, light rays, and the like. Generally, rays 305 are used to trace potential paths for light moving through the meshes to simulate the resulting visuals.

In addition to various material and other properties that affect the resulting subsurface scatting, one relevant feature is the number of intersections for each ray (e.g., the number of times the ray passes through the surface of a mesh (or otherwise encounters a mesh)). In the illustrated example, although the feature mesh 210 and base mesh 205 are discrete meshes, they are treated as a single mesh for subsurface scattering purposes. As illustrated by the ray 305A, some rays may intersect the base mesh 205 at a first point 310A, may then intersect a feature mesh 210 at a second point 310B, followed by exiting the feature mesh at point 310C, and finally exiting the base mesh at point 310D. Although the illustrated example depicts two rays 305 with specific paths, in aspects, the particular paths of each ray may vary.

In some systems, the modeling system may determine that the ray 305A intersected the mesh four times: once at point 310A, once at point 310B, once at point 310C, and once at point 310D. In some aspects, intersections where the ray 305A enters the mesh may be referred to as entry points and may be assigned a positive value (e.g., +1) while intersections where the ray 305A exits a mesh may be referred to as exit points and may be assigned a negative value (e.g., −1). For example, at point 310A, the value may be one. At point 310B, the value is incremented to two. At point 310C, the value is decremented to 1, and at point 310D, the value is decremented to zero. Therefore, when the ray 305A reaches the point 310D, the modeling system can determine that the ray has exited the mesh (e.g., because the aggregate sum is zero), and can compute the subsurface scattering calculations at this point 310D.

However, due to the mouth opening, these subsurface calculations may be inaccurate in some cases. Specifically, as illustrated by the ray 305B, the ray may intersect the meshes at a first point 310E (resulting in a value of +1), followed by exiting the mesh at point 310F (resulting in a value of zero). This may cause the subsurface scattering to terminate prematurely. Further, if the raytracing is continued, the ray 305B will reach a second exit point 310G, resulting in a negative value. This can result in inaccurate subsurface scattering.

In some embodiments of the present disclosure, therefore, the modeling system may re-map one or more faces of the feature mesh 210 to account for the gap in the base mesh 205. Specifically, in the illustrated example, the modeling system may assign the portion(s) of the feature mesh 210 that correspond to the internal side of the feature (e.g., the inside of the mouth) within the base mesh 205 to a higher value with respect to subsurface scattering. The relevant faces are indicated in the illustrated example using a bold line 315, and may be defined as part of the modeling process used to create the feature mesh 210. Specifically, in some embodiments, the modeling system may assign intersections that enter the feature mesh 210 on the relevant portion (indicated by the bold line 315) with a value of +2 to account for the missing portion of the base mesh 205. In the illustrated example, therefore, the ray 305B may have a value of +2 at the point 310E, a value of +1 at the point 310F, and a value of 0 at the point 310G.

In this way, the modeling system can effectively and efficiently perform accurate raytracing to implement subsurface scattering for the aggregated model. This can substantially improve the resulting rendered images, reducing visual artifacts and improving the resulting animations.

### Example Method for Modeling Meshes Using Detached Features

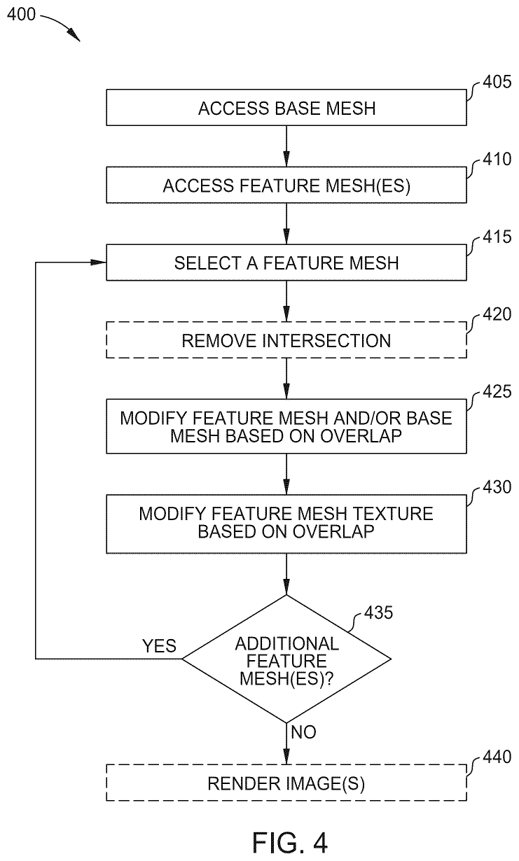

FIG. 4 is a flow diagram depicting an example method 400 for modeling meshes using detached features, according to some embodiments of the present disclosure. In some embodiments, the method 400 is performed by a modeling system, such as the modeling system 105 of FIG. 1 and/or the modeling systems discussed above with reference to FIGS. 2-3.

At block 405, the modeling system accesses a base mesh (e.g., the base mesh 110 of FIG. 1 and/or the base mesh 205 of FIGS. 2A-2D and/or 3). As discussed above, the base mesh may generally correspond to a 3D mesh (e.g., a closed mesh) corresponding to the all or a part of a 3D character (e.g., having the general shape and size of at least the head of the character). In some aspects, the base mesh may include one or more features having positions fixed relative to the base (e.g., the eyes, if the user does not desire the eyes to move independently of the head). In some embodiments, as discussed above, the base mesh may lack one or more features, such as the mouth of the character, the ear(s) of the character, the nose of the character, and the like.

At block 410, the modeling system accesses a set of one or more feature mesh(es) to be aggregated with the base mesh. As discussed above, the feature mesh(es) may generally correspond to 3D meshes (e.g., closed meshes) corresponding to one or more features if a 3D character (e.g., having the general shape and size of the features of the character). For example, the feature mesh(es) may correspond to facial features, such as the mouth of the character, the ear(s) of the character, the nose of the character, and the like. In some embodiments, as discussed above, the feature meshes may or may not have been designed specifically for the base mesh. That is, the modeling system may access features that were intended and modeled to be used with the head mesh, or may select the features using other techniques (including randomly or pseudo-randomly). For example, by selecting features (such as mouths, ears, noses, and the like) at least semi-randomly from a pool of such features, the modeling system may enable rapid creation of randomized characters (e.g., for background or crowd scenes) that still retain substantial detail and can still be animated accurately and reliably using the rigging and textures already defined for these features.

At block 415, the modeling system selects one of the feature mesh(es). Generally, the modeling system may select the feature mesh using any suitable technique or criteria, including randomly or pseudo-randomly, as all feature mesh(es) for the head mesh will be processed during the method 400.

At block 420, the modeling system optionally removes the intersection of the base mesh and the selected feature mesh. In some embodiments, as discussed above, the selected feature mesh may be associated with metadata or other information indicating whether any portions of the base mesh should be removed to fit the feature mesh (e.g., for a mouth opening). Other features (e.g., noses or ears) may not rely on such removal. In some embodiments, as discussed above, the modeling system may remove the intersection using a rig geometry for the feature mesh (e.g., indicating the current positioning of the intersection or overlap), such as by extruding the rig and removing portions of the base mesh that are inside of the extruded rig geometry (e.g., determined using SDF techniques). This allows the modeling system to rapidly and accurately remove the relevant portions of the base mesh. As discussed above, in some embodiments, removing the intersection may generally be implemented by deleting the relevant portion(s) of the base mesh, hiding the relevant portions, making the relevant portions transparent or invisible, and the like.

At block 425, the modeling system modifies the feature mesh and/or the base mesh based on the overlap between them. For example, as discussed above with reference to FIG. 2C, the modeling system may deform or move one or more portions of each mesh such that at the intersection point they are aligned and the alignment fades off (e.g., the amount that the modeling system moves each portion is reduced) moving away from the intersection (such that, at some maximum distance from the intersection, the modeling system does not move the mesh topologies). As discussed above, this automated mesh modification can blend the topologies of the feature and base meshes, enabling blended (e.g., visually seamless) rendering.

At block 430, the modeling system modifies the texture of the feature mesh based on the texture of the base mesh and based further of the overlapping regions. For example, as discussed above with reference to FIG. 2D, the modeling system may project the UV map of all or a portion of the base mesh to the feature mesh, and may then use this projected UV mapping to add texture from the base mesh to the feature mesh. In some embodiments, as discussed above, the modeling system may use a falloff over the overlapping region such that at one end the texture of the feature mesh matches the texture of the base mesh and at the other end the base mesh's texture has no impact on the texture of the feature mesh.

At block 435, the modeling system determines whether one or more additional feature mesh(es) remain to be integrated. If so, the method 400 returns to block 415. If not, the method 400 continues to block 440. Although the illustrated example depicts a sequential process (selecting and integrating each feature mesh iteratively) for conceptual clarity, in some embodiments, the modeling system may process some or all of the features meshes in parallel.

At block 440, the modeling system optionally renders one or more images of the combined base mesh and feature mesh(es). For example, as discussed above, the modeling system may output the images via a display to a user (e.g., an animator) to allow the user to modify the positioning, size, orientation, or other aspects of the feature mesh(es) and/or base mesh in order to match the artistic design. In some embodiments, the modeling system may render the images for final use (e.g., to be included in a computer animation, such as for a show, movie, short film, and the like).

In some embodiments, some or all of the method 400 can then be repeated (or performed in parallel) to create an animation. For example, the modeling system may determine an updated position, orientation, scale, or other aspect of one or more feature meshes and/or the base mesh, and may them perform the method 400 to move portion(s) of each mesh to align them, as discussed above, to generate an updated or second image depicting the new position and arrangement.

### Example Method for Computer Modeling

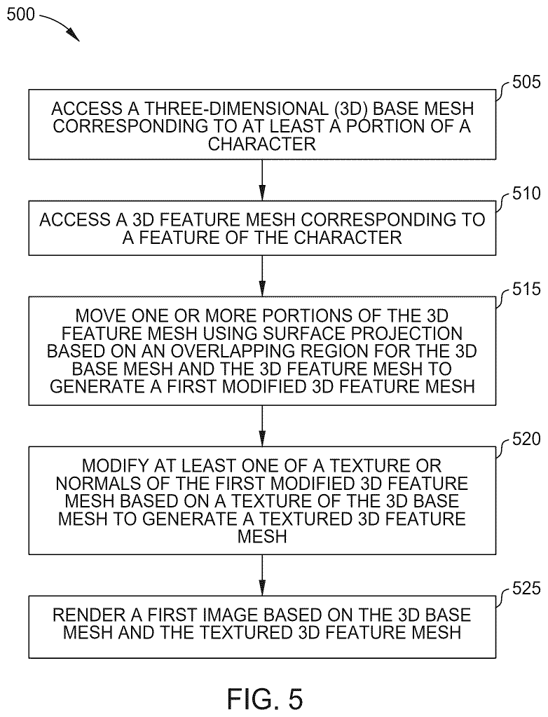

FIG. 5 is a flow diagram depicting an example method 500 for computer modeling, according to some embodiments of the present disclosure. In some embodiments, the method 500 is performed by a modeling system, such as the modeling system 105 of FIG. 1 and/or the modeling systems discussed above with reference to FIGS. 2-4.

At block 505, a 3D base mesh (e.g., the base mesh 110 of FIG. 1 and/or the base mesh 205 of FIGS. 2A, 2B, 2C, 2D, and/or 3) corresponding to at least a portion of of a character is accessed.

At block 510, a 3D feature mesh (e.g., the feature meshes 115 of FIG. 1 and/or the feature mesh 210 of FIGS. 2A, 2B, 2C, 2D, and/or 3) corresponding to a feature of the character is accessed.

At block 515, one or more portions of the 3D feature mesh are deformed using surface projection based on an overlapping region for the 3D base mesh and the 3D feature mesh to generate a first modified 3D feature mesh (e.g., as illustrated in FIG. 2C).

At block 520, at least one of a texture or normals of the first modified 3D feature mesh is modified based on at least one of a texture or normals of the 3D base mesh to generate a textured 3D feature mesh (e.g., as illustrated in FIG. 2D).

At block 525, a first image (e.g., the rendered image 120 of FIG. 1) is rendered based on the 3D base mesh and the textured 3D feature mesh.

### Example Computing Device for Detached Feature Modeling

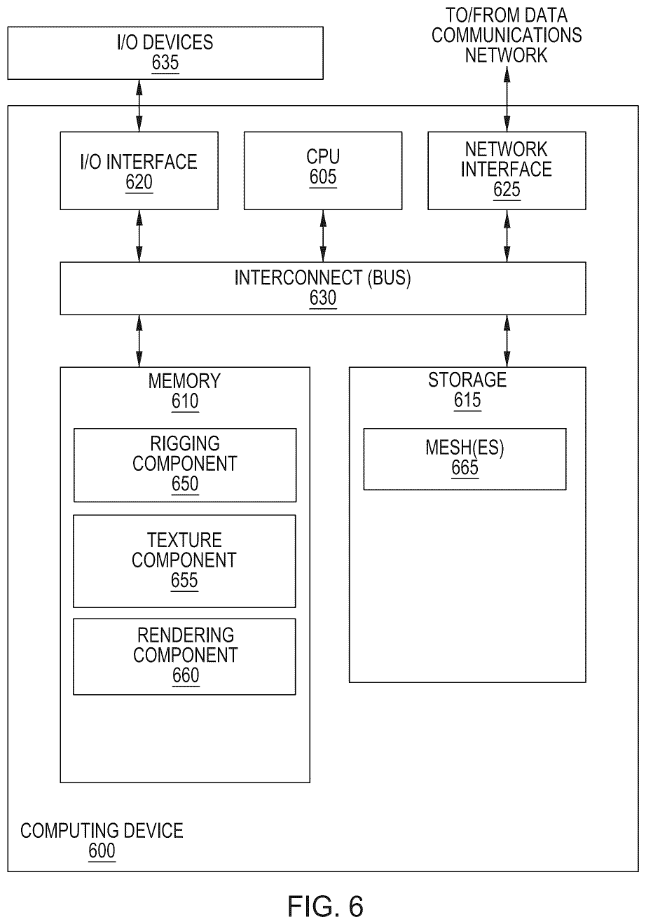

FIG. 6 depicts an example computing device 600 configured to perform various aspects of the present disclosure. In some embodiments, the computing device 600 corresponds to a modeling system, such as the modeling system 105 of FIG. 1 and/or the modeling systems discussed above with reference to FIGS. 2-6.

Although depicted as a physical device, in embodiments, the computing device 600 may be implemented as a virtual device or service, or across a number of devices (e.g., in a cloud environment). As illustrated, the computing device 600 includes a processor 605, memory 610, storage 615, I/O interface 620, and a network interface 625. In the illustrated embodiment, the processor 605 retrieves and executes programming instructions stored in memory 610, as well as stores and retrieves application data residing in storage 615. The processor 605 is generally representative of a single CPU, a GPU, a CPU and a GPU, multiple CPUs, multiple GPUs, a single CPU or GPU having multiple processing cores, and the like. The memory 610 is generally included to be representative of a random access memory. Storage 615 may be any combination of memory or storage components, including (but not limited to) disk drives, flash-based storage devices, and the like, and may include fixed storage devices, removable storage devices or a combination both, such as fixed disk drives, removable memory cards, caches, optical storage, network attached storage (NAS), or storage area networks (SAN).

In some embodiments, I/O devices 635 (such as a mouse, a keyboard, a monitor, a touchscreen, a GUI, etc.) are connected via the 1/O Interface(s) 620. Further, via the network interface 625, the computing device 600 can be communicatively coupled with one or more other devices and components (directly or indirectly), such as content servers, via one or more networks.

As illustrated, the memory 610 includes a rigging component 650, a texturing component 655, and a rendering component 660. Although depicted as software residing in memory, in embodiments, the functionality of the depicted components (and others not depicted) may be implemented using hardware, software, or a combination of hardware and software. In some embodiments, the memory 610 may be used to temporarily store the depicted components while the processor 605 executes the instructions of each during runtime. In some aspects, the components may otherwise reside in another location, such as in storage 615.

The depicted components are generally configured to perform one or more embodiments disclosed herein. For example, in one embodiment, the rigging component 650 (which may correspond to the rigging component 125 of FIG. 1) is used to modify mesh(es) to integrate feature meshes onto base meshes, as discussed above. For example, the rigging component 650 may remove portion(s) of the base mesh(es) and/or feature mesh(es), and/or may move (e.g., translate) one or more portions of the feature mesh(es) and/or base model(s) to align the meshes based on the overlap or intersection, as discussed above.

The texturing component 655 (which may correspond to the texturing component 130 of FIG. 1) may be used to modify the texturing the feature meshes, as discussed above. For example, as discussed above, the texturing component 655 may map the texture from the base mesh to one or more portions of the feature mesh (e.g., based on the overlap region). The rendering component 660 (which may correspond to the rendering component 135 of FIG. 1) may be used to apply subsurface scattering (e.g., discussed above with reference to FIG. 3) and/or render image(s) (e.g., the rendered image(s) 120 of FIG. 1), as discussed above.

In the illustrated embodiment, the storage 615 includes a set of meshes 665. Though depicted as residing in storage 615 for conceptual clarity, in embodiments, the meshes 665 may reside in any suitable location. The meshes 665 may generally correspond to any three-dimensional meshes, such as the base mesh 110 of FIG. 1, the feature meshes 115 of FIG. 1, the base mesh 205 of FIGS. 2A, 2B, 2C, 2D, and/or 3, and/or the feature mesh 210 of FIGS. 2A, 2B, 23C, 2D, and/or 3.

### Additional Considerations

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
accessing a three-dimensional (3D) base mesh corresponding to at least a portion of a character;
accessing a 3D feature mesh corresponding to a feature of the character;
deforming one or more portions of the 3D feature mesh using surface projection based on an overlapping region for the 3D base mesh and the 3D feature mesh to generate a first modified 3D feature mesh;
modifying at least one of a texture or normals of the first modified 3D feature mesh based on at least one of a texture or normals of the 3D base mesh to generate a textured 3D feature mesh; and
rendering a first image based on the 3D base mesh and the textured 3D feature mesh.

2. The method of claim 1, further comprising:
determining an intersecting portion of the 3D base mesh that intersects with the 3D feature mesh; and
removing the intersecting portion from the 3D base mesh.

3. The method of claim 2, wherein determining the intersecting portion comprises:
extruding a rig geometry corresponding to an outline of the 3D feature mesh;
generating a signed distance field (SDF) based on the extruded rig geometry and the 3D base mesh; and
determining the intersecting portion based on the SDF.

4. The method of claim 1, further comprising deforming one or more portions of the 3D base mesh based on the overlapping region, comprising blending the overlapping region based on aligning at least some of the one or more portions of the 3D base mesh and the 3D feature mesh.

5. The method of claim 1, wherein modifying the at least one of the texture or the normals of the first modified 3D feature mesh comprises blending the texture of the 3D base mesh with the texture of the 3D feature mesh based on the overlapping region.

6. The method of claim 1, wherein the feature of the character comprises at least one of: (i) a mouth of the character, (ii) an ear of the character, or (iii) a nose of the character.

7. The method of claim 1, wherein the 3D base mesh lacks at least one of: (i) a mouth of the character, (ii) an ear of the character, or (iii) a nose of the character.

8. The method of claim 1, further comprising:
determining an updated position of the 3D feature mesh;
deforming one or more portions of the 3D feature mesh to generate a second modified 3D feature mesh; and
rendering a second image based on the 3D base mesh and the second modified 3D feature mesh.

9. One or more non-transitory computer readable media containing, in any combination, computer program code that, when executed by operation of a computing system, performs operations comprising:
accessing a three-dimensional (3D) base mesh corresponding to at least a portion of a character;
accessing a 3D feature mesh corresponding to a feature of the character;
deforming one or more portions of the 3D feature mesh using surface projection based on an overlapping region for the 3D base mesh and the 3D feature mesh to generate a first modified 3D feature mesh;
modifying at least one of a texture or normals of the first modified 3D feature mesh based on at least one of a texture or normals of the 3D base mesh to generate a textured 3D feature mesh; and
rendering a first image based on the 3D base mesh and the textured 3D feature mesh.

10. The one or more non-transitory computer readable media of claim 9, the operations further comprising:
determining an intersecting portion of the 3D base mesh that intersects with the 3D feature mesh; and
removing the intersecting portion from the 3D base mesh.

11. The one or more non-transitory computer readable media of claim 10, wherein determining the intersecting portion comprises:
extruding a rig geometry corresponding to an outline of the 3D feature mesh;
generating a signed distance field (SDF) based on the extruded rig geometry and the 3D base mesh; and
determining the intersecting portion based on the SDF.

12. The one or more non-transitory computer readable media of claim 9, the operations further comprising deforming one or more portions of the 3D base mesh based on the overlapping region, comprising blending the overlapping region based on aligning at least some of the one or more portions of the 3D base mesh and the 3D feature mesh.

13. The one or more non-transitory computer readable media of claim 9, wherein modifying the at least one of the texture or the normals of the first modified 3D feature mesh comprises blending the texture of the 3D base mesh with the texture of the 3D feature mesh based on the overlapping region.

14. The one or more non-transitory computer readable media of claim 9, the operations further comprising:
determining an updated position of the 3D feature mesh;
deforming one or more portions of the 3D feature mesh to generate a second modified 3D feature mesh; and
rendering a second image based on the 3D base mesh and the second modified 3D feature mesh.

15. A system, comprising:
one or more processors;
one or more memories storing a program, which, when executed on any combination of the one or more processors, performs operations, the operations comprising:
accessing a three-dimensional (3D) base mesh corresponding to at least a portion of a character;
accessing a 3D feature mesh corresponding to a feature of the character;
deforming one or more portions of the 3D feature mesh using surface projection based on an overlapping region for the 3D base mesh and the 3D feature mesh to generate a first modified 3D feature mesh;
modifying at least one of a texture or normals of the first modified 3D feature mesh based on at least one of a texture or normals of the 3D base mesh to generate a textured 3D feature mesh; and
rendering a first image based on the 3D base mesh and the textured 3D feature mesh.

16. The system of claim 15, the operations further comprising:
determining an intersecting portion of the 3D base mesh that intersects with the 3D feature mesh; and
removing the intersecting portion from the 3D base mesh.

17. The system of claim 16, wherein determining the intersecting portion comprises:
extruding a rig geometry corresponding to an outline of the 3D feature mesh;
generating a signed distance field (SDF) based on the extruded rig geometry and the 3D base mesh; and
determining the intersecting portion based on the SDF.

18. The system of claim 15, the operations further comprising deforming one or more portions of the 3D base mesh based on the overlapping region, comprising blending the overlapping region based on aligning at least some of the one or more portions of the 3D base mesh and the 3D feature mesh.

19. The system of claim 15, wherein modifying the at least one of the texture or the normals of the first modified 3D feature mesh comprises blending the texture of the 3D base mesh with the texture of the 3D feature mesh based on the overlapping region.

20. The system of claim 15, the operations further comprising:
determining an updated position of the 3D feature mesh;
deforming one or more portions of the 3D feature mesh to generate a second modified 3D feature mesh; and
rendering a second image based on the 3D base mesh and the second modified 3D feature mesh.
